(19) United States
(12) Patent Application Publication
(10) Pub. No.: US 2001/0053398 A1
(43) Pub. Date: Dec. 20, 2001

(54) CHEESE WHEY PROTEIN HAVING IMPROVED TEXTURE PROCESS FOR PRODUCING THE SAME AND USE THEREOF

(76) Inventor: TAKAHIKO SOEDA, KAWASAKI-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/339,114

(22) Filed: Jun. 24, 1999

(30) Foreign Application Priority Data
Jun. 24, 1998 (JP) 176988/1998

(51) Int. Cl. A23C 20/00

(52) U.S. Cl. 426/34; 426/582; 426/583

(57) ABSTRACT

A process for producing a modified cheese whey protein, comprising:

a)either adjusting the pH of an aqueous solution containing cheese whey protein to an alkaline pH; or heating an aqueous solution containing cheese whey protein; or adjusting the pH of an aqueous solution containing cheese whey protein to an alkaline pH and heating the solution;

b) and thereafter reacting the cheese whey protein with transglutaminase to obtain a modified cheese whey protein.

### BACKGROUND OF THE INVENTION

1. Field of the Invention

The present invention relates to a novel cheese whey protein having improved texture and a process for producing the same. In particular, a process for producing a cheese whey protein-containing powder, which comprises heating a cheese whey protein-containing solution to 80° C. or less and adjusting the pH to 7 or more. These treatments are then followed by reacting the cheese-whey protein with transglutaminase. The resultant product is heated to a high temperature, dried and then used in making food products.

This modified cheese whey protein can be used in processed foods such as poultry, meat, fish, dairy products, egg products, beverages and health foods. Additionally, the modified cheese whey protein can be used in these and other food products that require gelation, emulsifiability and foamability.

1. Discussion of the Background

Cheese whey protein is a by-product formed during the production of cheese. The recovery of cheese whey proteins is important because it makes efficient use for what is considered a waste product, thereby conserving resources and ultimately promoting environmental conservation. The cheese whey proteins are particularly useful as an additive to common foods to increase the nutritive value, owing to its high protein and carbohydrate content, with almost no fat.

In recent years, as the effective use of natural resources has become a major issue, attempts have been made to use ingredients of the cheese whey directly, namely the proteins, carbohydrates and minerals, in foods with little additional processing of the cheese whey. Studies directed to the efficient recovery of proteins from the whey solutions, suitable for use in food material, have been met with some difficulty.

Conventionally, production of cheese whey protein concentrates were obtained by ultra-filtration and thereby resulted in a protein content of 50 to 70%. However, recent production of cheese whey protein concentrates, with a protein content of 90% or more, have been made. These cheese whey protein concentrates are shown to have improved gelation capacity, emulsifiability and foamability. However, when these cheese whey proteins are used in various food products, the foods obtained have poor palatable characteristics and negative chewing and swallowing organoleptic properties. These negative characteristics are particular to cheese whey proteins as they are not observed with all milk proteins, i.e., casein protein.

To attempt to improve the texture of the cheese whey protein, past methods have employed a process of hydrolyzation, of the cheese whey proteins, with various enzymes. These processes, however, lead to decreased gelation capacity, a desirable property of the cheese whey protein in the production of certain food material.

Attempts to increase the gel strength of cheese whey proteins have incorporated a step of high heat treatment into the process, wherein, an unmodified cheese whey protein powder is directly contacted with steam, at a temperature of 110 to 130° C. for 10 to 20 seconds. This treatment results in an improvement of the gel strength of the protein and results in a decrease in the number of bacteria (refer to JP-B-7-108191). However, whereas this method is effective in increasing gel strength and killing bacteria, this method fails to result in a product with good organoleptic properties.

Other attempts to improve the properties of the modified cheese whey protein have used partial denaturation of the cheese whey proteins, wherein the degree of denaturation is from 55 to 80%, to produce a cheese whey protein having an average particle diameter of 40 to 50 μm. When these denatured cheese whey proteins are used as a food additive, i.e., in mayonnaise, salad, and ice cream (JP-W-7-507452), it is observed to have fair organoleptic properties during chewing and swallowing. However, this process has not yet solved the problem concerning the texture during chewing and swallowing. Using this method, an amount of the undesirable rough texture, from the starting cheese whey protein, is still prevalent.

In consideration of the fact that industrial heat sterilization is generally conducted at a high temperature for a short period of time for inhibiting denaturation of proteins, insolubilization of proteins through heating at 100° C. or more is important. In general, the change of proteins varies greatly through heating at 100° C. or more. From this standpoint, there is no information on insolubilization of proteins at 100° C. or more in relation to the cheese whey.

Furthermore, when sodium chloride, a common additive used in making food products, is added to the cheese whey protein and a heated gel is prepared, the cheese whey proteins lose cohesiveness and water holding capacity, and have a chewing organoleptic property similar to a dry fibrous material. This is a significant problem if the cheese whey proteins are to be developed and used into a commercially viable material in the production of food products.

### SUMMARY OF THE INVENTION

This invention is directed to a process to develop modified cheese whey proteins and food products containing the cheese whey proteins that solves the problems associated with other processing methods, namely poor palatability and negative organoleptic properties during chewing and swallowing. Furthermore, this invention provides modified cheese whey proteins that are not significantly insolubilized by the heat sterilization methods commonly used in food material preparation.

### DETAILED DISCUSSION OF THE INVENTION

The inventors have found that to solve the problems the cheese whey protein may be first treated in alkaline conditions while heating, followed by reacting with transglutaminase, which may or may not be also carried out in alkaline conditions and with heating. Surprisingly, this process results in high quality modified cheese whey-protein possessing excellent organoleptic properties, in particular, during chewing and swallowing. Additionally, this process results in a product, that when heated to 100° C. or more, has excellent texture, and excellent feeling during swallowing, and maintain properties such as emulsifiability, foamability, and high water holding capacity. Additionally, the gel obtained from the treated cheese whey protein or the food using the same has excellent texture, and excellent feeling during swallowing, and maintain properties such as emulsifiability, foamability, and high water holding capacity.

In the invention, the protein network structure of the cheese whey protein is rendered dense using the crosslinking polymerization activity of transglutaminase, wherein it catalyzes intermolecular or intramolecular ε-(γ-Glu) Lys crosslinking between glutamine and lysine of a protein to impart a dissolution stability. In addition, the combination of pH adjustment and/or heat treatment described in the present invention can provide further improvement of transglutaminase activity. As a result, it is possible to improve the dissolution instability of the cheese whey protein by aggregation. This improves the texture of the solution or gel of the cheese whey proteins, and therefore, is suitable for use in a variety of food products.

It is an object of the invention to provide a process for producing cheese whey protein which is improved in the above-mentioned physical and organoleptic properties, especially in texture. It is also an object of the invention to use the cheese whey protein in food materials and products.

The invention is a cheese whey protein which is obtained by a process including a step of reacting cheese whey proteins with transglutaminase, comprising one or both of the following two steps, and a food containing or using the resultant proteins:

(a) adjusting the pH of an aqueous solution comprising cheese whey protein into an alkaline pH and/or with heating prior to the reaction of the proteins with transglutaminase wherein, heat treatment may be up to 80° C., including 10, 20, 30, 40, 50, 60, 70° C. and inclusive of all values and subranges there between,

(b) reacting the cheese whey protein with transglutaminase under alkaline conditions and/or while heating at a temperature that does not inactivate the transglutaminase.

Further physical or chemical treatments other than the above-mentioned treatments are also included in the invention, excluding those that would result in an inability to obtain an object of the invention.

In particular, it is an object of the invention that the cheese whey proteins are first heated under alkaline conditions prior to reacting with transglutaminase. Furthermore, it is preferred that the reaction between the cheese whey proteins and transglutaminase be under alkaline conditions while heating, for a time and temperature that does not inactivate the transglutaminase.

It is an object of the invention to treat the whey proteins under alkaline conditions while heating in (a) simultaneously, though they may also be conducted separately. Similarly, when the cheese whey protein is reacted with the transglutaminase under alkaline conditions and heated in (b), it is preferred to conduct the reaction with the transglutaminase in alkaline conditions, while heating simultaneously. Further, when (b) is conducted after (a), it is preferred to maintain alkaline conditions in the first heating and subsequently maintain heating when reacting with transglutaminase, as in (b).

It is an object of the invention that a heating temperature, during the reaction with transglutaminase, not exceed the temperature in which the transglutaminase is inactive. Furthermore, it is preferred that a heating temperature of 60° C. or less, including 10, 20, 30, 40, 50° C., and inclusive of all values and ranges there between, be used when transglutaminase is reacting with the cheese whey proteins.

The reaction may also be performed without additional heating, wherein the reaction is maintained at room temperature, including 15, 25, 35, 45° C., inclusive of all values and subranges there between.

It is an object of the invention that the modified cheese whey proteins, obtained by the processes of the present invention, having improved texture and excellent organoleptic properties, be used in food products and materials.

It is an object of the invention that the modified cheese whey protein obtained by the processes of the present invention be made and kept in powder form, and using said protein in food products or other methods of using said protein in powder form.

It is an object of the invention for a process for producing a modified cheese whey protein comprising, first adjusting the pH of the cheese whey protein to an alkaline pH and heating the cheese whey protein for a time and temperature to improve the properties of the whey proteins in the subsequent reaction with transglutaminase, and/or reacting the cheese whey protein with the transglutaminase under alkaline conditions and/or while heating at a temperature that does not inactivate the transglutaminase.

It is an object of the invention wherein the process of producing the modified cheese whey protein first includes adjusting the pH of the cheese whey protein to an alkaline pH and heating up to and including 80° C., including 10, 20, 30, 40, 50, 60, 70° C. inclusive of all values and subranges there between. It is also an object of the invention that this treatment is followed by reacting said proteins with transglutaminase in alkaline conditions and heating, to a temperature and a time that does not inactivate the transglutaminase.

It is an object of the invention that the pH adjustment and heating in (a) be conducted simultaneously. Also it is preferred that the alkaline conditions be maintained during the entire reaction, including when the reacting cheese whey protein and transglutaminase are heated to a temperature at a temperature and for a time that does not inactivate the enzyme.

It is preferred that the amount of the transglutaminase used in the reaction with the cheese whey proteins is from 0.1 to 100 units per gram of the cheese whey protein contained in the reaction, including 1, 10, 20, 30, 40, 50, 60, 70, 80, 90 units per gram, inclusive of all values and subranges there between.

It is an object of the invention that before and/or after reacting with transglutaminase the pH be adjusted to a pH of 7 to 9.

It is further an object of the invention that following the reaction of cheese whey proteins with transglutaminase, the reaction product is heated and dried. Also, it is an object of the invention to heat treat the reaction product, suitable for sterilization.

It is an object of the invention that the heating of the cheese whey protein prior to reacting with transglutaminase be at a temperature from 50 to 80° C., including 50, 55, 65, 70, 75° C., inclusive of all values and subranges there between.

It is an object of the invention that the alkaline pH of the cheese whey protein and the heating of the cheese whey protein, prior to reacting with transglutaminase, is up to 2 hours, including 10 minutes, 30 minutes, 1 hour, 1.5 hours, inclusive of all values and subranges there between, whether the heating is conducted simultaneously or separately from the pH adjustment.

It is an object of the invention that the cheese whey protein, obtained by the process described in the present invention, be used in a food product or food containing product.

It is an object of the invention that the cheese whey protein be maintained in a powdery form whereby this form will increase the shelf life and workability of said cheese whey proteins during use in food products. The cheese whey protein to be modified or a composition containing the same which is used as a starting material in the invention contains a cheese whey protein obtained as a by-product in the production of cheese, using milk as a raw material. Main components thereof in the solid are proteins and lactose. With respect to the cheese whey protein commonly used as the starting material of the invention, a standard composition in the form of a protein-containing solution is preferably a composition comprising 94.5% of water, approximately 0.5% of protein, approximately 4.5% of saccharides, 0.5% of ash and a trace amount of fat, or a concentrate obtained by concentrating them to approximately 2 to 10 times through ultra-filtration. Further, a cheese whey protein-containing solution is also available which is obtained by using a commercial cheese whey protein-containing powder having a protein content of 30% or more and adding water thereto until the protein content becomes 10% or less.

Transglutaminases are divided into calcium-independent and calcium-dependent types. Either can be used in the present invention. Examples of the calcium-independent type include those derived from microorganisms such as Actinomycetes, Bacillus subtilis and the like (see for example, JP-A-64-27471). Examples of the calcium-dependent type include those derived from guinea pig liver (see, for example, JP-B-1-50382), microorganisms such as Oomycetes, bovine blood, swine blood, other types of animal blood, salmon, red sea bream, other types of fish (see, for example, Seki Nobuo et al., Nippon Suisan Gakkaishi, vol. 56, NO. 1, pp. 125132 (1990)), oysters, and similar sources. Also, transglutaminases may be produced by methods of genetic engineering (see, for example, JP-A-1-300889, JP-A-6-225775, JP-A-7-23737). Other possible sources of transglutaminase are also included in this invention. According to the present invention, any of these transglutaminases can be used, with no specific limitation on the origin and the preparation. However, in view of the function and economic considerations in food applications, the calcium-independent transglutaminases are preferable. For example, the transglutaminases derived from the microorganisms, mentioned above (JP-A-64-27471), meet any conditions, and are preferred enzymes.

Transglutaminases which will be developed and found in the future can also be used in the invention so long as they have the transglutaminase activity.

A cheese whey protein solution, with a protein content of 0.5 to 10%, is adjusted to an alkaline pH with an alkaline substance. The alkaline substance is used to adjust the pH of the solution to pH 7, 8 or 9, inclusive of all values and subranges there between. In particular, hydroxide, carbonate, phosphate or other alkaline substances can be used in the pH adjustment. Either following or preceding the pH adjustment, the cheese whey proteins may be heated. It is preferred, however, that the heating occur after the alkali treatment. The cheese whey proteins may be heated to 80° C., including 50, 60, 70° C., inclusive of all values and subranges there between. This heating may occur from 10 seconds to 120 minutes, including 1, 10, 30, 60, 90 minutes, inclusive of all values and subranges there between. When the heating is for a short time, 5 minutes or less, a high temperature instantaneous heater fitted with a heat exchange plate can be used. When the heating is greater than 5 minutes, it may be performed batchwise using a tank.

The cheese whey protein-containing solution which is adjusted to an alkaline pH and heated, is then reacted with transglutaminase. The preferred amount of transglutaminase reacting with the cheese whey protein is from 0.1 to 100 units per gram of protein, in solution, including 1, 10, 20, 30, 40, 50, 60, 70, 80, 90 units, inclusive of all values and ranges there between. It is further preferred that the amount of transglutaminase used is from 0.5 to 50 units per gram of protein, in solution. The reacting of the cheese whey protein with the transglutaminase is preferably conducted under alkaline conditions. Furthermore, it is preferred that the reaction be maintained in alkaline conditions during the reaction by adjustment with the aforementioned alkaline agents. When the transglutaminase used is less than 0.1 units, the heat aggregation is unchanged, and the rough texture, inherent in the cheese whey proteins, is not improved compared with unreacted cheese whey proteins. Addition of more than 100 units may not result in any additive or positive effect over that obtained by the use of transglutaminase up to 100 units. Thus, the addition of more than 100 units is not preferred.

The activity of the transglutaminase may be determined by reacting transglutaminase with the substrates, benzyloxycabonyl-L-glutaminylglycine and hydroxylamine. The hydroxamic acid obtained from the reaction is further reacted with trichloroacetic acid to generate an iron complex. The absorbance of the iron complex is measured at 525 nm. The amount of hydroxamic acid is then calculated by comparison to a standard curve. The amount of hydroxamic acid generated is directly related to the activity of transglutaminase in the initial reaction and therefore can be used to calculate said activity (refer to JP-A-64-27471).

During the transgluatminase and cheese whey protein reaction, the preferred temperature of heating is from 0 to 60° C., including 10, 20, 30, 40, 50° C., inclusive of all values and subranges there between. A preferred reaction time is between 5 minutes and 48 hours, including 30 minutes, 1 hour, 5 hours, 10 hours, 20 hours, 30 hours, inclusive of all values and subranges there between. Additionally, preferred reaction conditions include a reaction temperature from 20 to 50° C. for a reaction time of 30 minutes to 2 hours. In particular, it is preferred that the temperature does not inactivate the transglutaminase in the reaction; i.e., a temperature of higher than 60° C. Following the reaction, the cheese whey protein and transglutaminase solution may be neutralized. However, the pH may remain alkaline where the use of such modified cheese whey proteins may be useful. The pH value is adjusted to approximately a neutral region, from 6 to 7.5, inclusive of all values and subranges there between. When the cheese whey proteins are to be used in foods the pH is preferably 7 or less. An aqueous solution of inorganic or organic acid may be used as the neutralizing agent, wherein the type of acid is not particularly limited.

Following reneutralization, the protein-containing solution is heated from 80 to 140° C., including 90, 100, 110, 120, 130° C., inclusive of all values and subranges there between, for 1 second to 120 minutes, including 0.5, 1, 10, 30, 60, 90 minutes, inclusive of all values and subranges there between. To heat the reaction, the UHT method may be employed, wherein the treatment is conducted at a high temperature for a short period of time. An indirect method in which steam is passed through a plate or a direct method in which steam is directly fed to a protein solution may be used. According to the present invention, insolubilization of the protein by aggregation does not occur even upon heating at 100° C. or more.

After the heating, the product is dried. To dry the product, a spray-drying method is preferred because of its economic advantages and involves the use of a spray drier or a disk drier. To minimize heat denaturation of the protein, during the drying process, it is preferable to maintain an exhaust temperature in the drier at 80° C. or less.

A cheese whey protein powder can be produced through the above-mentioned steps in the absence of bacteria and with the excellent organoleptic properties described for these proteins.

The modified cheese whey protein made by the processes of the present invention can be used in various foods or may be further modified. These are all included in the invention.

Foods containing or using the modified cheese whey protein of the present invention include gel-like foods, emulsified foods, bread, confectionery and other foods where the modified cheese whey proteins would be useful.

For example, gel-like foods may include, but are not limited to, ham, sausage, kamaboko (boiled fish paste), chikuwa (cooked fish paste), satsumaage (fried fish paste), jelly, custard pudding, egg tofu, chawanmushi (pot-steamed hotchpotch) and noodles. Emulsified foods may include, but are not limited to, ice cream, yogurt, cheese and lactic acid beverages. Bread and confectionery foods may include, but are not limited to, bread, pastries, cookies and biscuits. Other foods where the cheese whey proteins would be useful may include, but are not limited to, mousse and chocolate.

As is understandable from the foregoing description, the cheese whey protein of the invention can be widely used and it is expected for many other uses.

Having generally described this invention, a further understanding can be obtained by reference to certain specific examples which are provided herein for purposes of illustration only, and are not intended to be limiting unless otherwise specified.

### EXAMPLES

### Example 1

### Production of a Modified Cheese Whey Protein

A cheese whey solution, obtained as a by-product in cheese production was concentrated by ultra-filtration to obtain a whey concentrate with a protein content of approximately 2%. The pH of the whey concentrate solution was adjusted to pH 8 with an aqueous sodium hydroxide solution and then heated at 60° C. for 15 minutes. Following this treatment, transglutaminase, obtained from Streptoverticillium mobaraense, genus Streptoverticillium actinomycetes (IPO 13819) (supplied by Ajinomoto Co., Inc, specific activity 1,000 units/gram), was added at a concentration of 1 unit per gram of the protein, in solution. The mixture was incubated at 25° C. for 60 minutes. Subsequently, the pH of the solution was adjusted to pH 7 with an aqueous solution of hydrochloric acid, and then concentrated by ultra-filtration. This resulted in a solution with a protein content of approximately 20%. This concentrate was then heated at 110° C. for 30 seconds using a plate-system indirect steam heating method, jetted into a cyclone held at reduced pressure of 600 mmHg, and then rapidly cooled to 60° C. The product was spray dried at approximately 160° C. to obtain a cheese whey protein concentrate (invention product).

A cheese whey protein concentrate was also produced in a similar manner as the invention product except that the transglutaminase was directly used without adjusting the pH or heating the cheese whey protein solution (Comparative Example 1). Additionally, a cheese whey protein concentrate was produced in the same manner as the invention product except that pH adjustment, heating, and transglutaminase reaction were not conducted (Comparative Example 2).

These cheese whey protein powders were then tested for gelation capacity. Water (85 g) and 3 g of sodium chloride were mixed with 15 g of the cheese whey protein concentrate powder (invention product, Comparative Example 1 and Comparative Example 2). The mixture was then packed into a casing tube (folding width, 47 mm). Subsequently, the product was heated in hot water of 85° C. for 30 minutes, and then cooled to room temperature with tap water to form a gel for evaluation.

The gel strength was determined by cutting each product into round slices having a thickness of 15 mm. These cut pieces were then measured for the gel strength (kg) using a rheometer, supplied by Fudo Kogyo K. K., with a spherical plunger having a diameter of 5 mm. The results of these tests are shown in Table 1.

To test for water holding capacity of the gel, gel pieces were cut into round slices with a thickness of approximately 5 to 6 mm. These slices were then held from both sides with a filter paper and an aqueous load of 2 kg was applied for 30 seconds. The water holding capacity (%) was calculated from the difference in weight between the gel before the load application and the gel after the load application (Table 1).

The invention product, Comparative Example 1 and Comparative Example 2 were each used in the preparation of food products and the organoleptic properties during chewing and swallowing were evaluated (Table 2).

TABLE 1

| | Gel strength | Water retention |
|---|---|---|
| Sample | (kg) | (%) |
| Invention product | 0.331 | 85.0 |
| Comparative | 0.254 | 55.3 |
| Example 1 | | |
| Comparative | 0.142 | 48.1 |
| Example 2 | | |

TABLE 2

| | Summary of Organoleptic |
|---|---|
| | properties of foods containing |
| Sample | modified cheese whey proteins |
| invention product | very smooth texture |
| | feels smooth during chewing |
| | positive feeling during swallowing |
| Comparative Example 1 | hard texture |
| | feels like aggregate of particles during chewing |
| | negative feeling during swallowing |
| Comparative Example 2 | rough texture |
| | feels like fibrous material during chewing |
| | negative feeling during chewing |

### Example 2

### Production of a Modified Cheese Whey Protein

One hundred parts of a cheese whey protein concentrate powder (WPC, supplied by Kyodo Nyugyo K. K., protein content approximately 35%) were dissolved in 900 parts of water. The solution was adjusted to a pH of 7.5 with sodium carbonate, and preheated at 80° C. for 15 seconds. To this solution, 5 units per gram of the protein, of the same transglutaminase as that used in Example 1 were added, and the mixture was maintained at 50° C. for 30 minutes. This transglutaminase-treated solution was heated at 120° C. for 10 seconds by blowing hot steam using an ejector-like mixing tube to conduct the heat, jetted into a cyclone held at reduced pressure of 600 mmHg, and rapidly cooled to 60° C. The resulting mixture was spray-dried at approximately 160° C. to obtain a cheese whey protein concentrate. This concentrate was then treated in the same manner as in Example 1. The resulting salt-added gel had a high water holding capacity of 81.6%, and possessed excellent organoleptic properties during swallowing and chewing.

A cheese whey protein (Comparative Example 3) prepared through the reaction with the transglutaminase without conducting the alkaline and heat treatment was prepared as in Example 1. This cheese whey protein concentrate had a poor water holding capacity and a poor texture that resulted in bad organoleptic properties during swallowing and chewing. Thus, this protein was not desirable in comparison with the invention product.

### Example 3

### Production of a Modified Cheese Whey Protein

One hundred parts of a separated cheese whey protein (WPC, supplied by Nissei Kyoeki K. K., protein content 85%) were dissolved in 1,500 parts of water, and the solution was adjusted to a pH of 9 with sodium hydroxide. Subsequently, 0.5 units transglutaminase (specific activity 1,000 units/g), used in Example 1, were added, and the mixture was maintained at 50° C. for 90 minutes. This solution was then neutralized to a pH of 7 with sodium hydroxide, maintained at 120° C. for 10 seconds by blowing hot steam using an ejector-like mixing tube to conduct heating, thereafter jetted into a cyclone held at a reduced pressure of 600 mmHg, and rapidly cooled to 60° C. The resulting mixture was spray-dried at approximately 160° C. to obtain a cheese whey protein concentrate. This concentrate was then treated in the same manner as in Example 1. The resulting salt-added gel had a high water holding capacity of 83.8%, and had excellent organoleptic properties during swallowing and chewing.

### Example 4

### Production of Kamaboko

One thousand grams of a flaky paste obtained by flaking frozen on ship surimi (fish paste) of Alaska pollack (“SA- grade Surimi”, supplied by Marutia K. K.), 30 g of sodium chloride and 600 g of ice water were mixed well using a Stephan cutter. Subsequently, 50 g of potato starch (“Esusan Ginrei”, supplied by Ajinomoto Co., Ltd. 50 g of sugar, 20 g of sweet sake (mirin), 10 g of a seasoning powder and 30 g of the invention product obtained in Example 1 were added, and then mixed at a final product temperature of 10° C. or less using a Stephan cutter. The resulting paste was packed into a casing tube, warmed at 30° C. for 60 minutes for setting, then heated at 90° C. for 30 minutes, and cooled to prepare casing kamaboko. The resulting kamaboko was subjected to organoleptic evaluation. This kamaboko had a stiffness and was smooth with a good feeling during swallowing, as would be expected in kamaboko.

### Example 5

### Production of Sausage

One thousand grams of pork lean meat, 400 g of pork fat, 30 g of sodium chloride and 400 g of ice water were mixed well using a Stephan cutter. Subsequently, 50 g of a starch (“Esusan Ginrei”, supplied by Ajinomoto Co., Inc.), 10 g of a seasoning powder and 30 g of the invention product obtained in Example 1 were added, and these were mixed using a Stephan cutter such that a final product temperature reached 10° C. The thus-obtained meat paste was packed into edible casing tubes, dried in a smoking chamber at 60° C. for 30 minutes, then smoked at the same temperature for 15 minutes, and finally cooked with steam at 80° C. for 40 minutes. The sausages were elastic and smooth with good organoleptic properties during chewing and swallowing, as would be expected in sausages.

### Example 6

### Production of an Ice Cream

Eight-hundred grams of fresh cream, 310 g of milk, 480 g of whole eggs, 12 spoonfuls of sugar and 20 droplets of a vanilla essence were mixed well. Added to this mixture was a solution of the invention product (30 g), made in Example 1, dissolved in 60 g of water. The resulting solution was allowed to stand overnight in a refrigerator, wherein the product temperature decreased to 10° C. or less. An inner pot of a home ice cream making machine (“Donbie”, supplied by Nippon Keikinzoku K. K.) had been placed overnight in a refrigerator of −18° C. or less for advance cooling. The refrigerated ice cream mix at 10° C. or less was put into the inner pot and the ice cream machine was used until the ice cream preparation was complete. The ice cream produced with the cheese whey protein concentrate was smooth with excellent organoleptic properties during swallowing, as would be expected in ice cream.

### Example 7

### Production of Yogurt

A whole milk powder (78 g), 76 g of a skim milk powder, 32 g of the invention product, obtained in Example 1, and 1,820 g of water were mixed, with stirring, into a 5-liter beaker until the powder had dissolved. This mixture was cooled to 45° C., 30 g of lactic acid bacteria starter (“Joghurt V2”, supplied by Wiesby) was added and fermented at 44° C. When the pH value reached 4.6 after about 3 hours of fermentation, the resulting yogurt was cooled to 10° C. The yogurt produced with the cheese whey protein concentrate was smooth and had excellent organoleptic properties, as would be expected in yogurt.

Obviously, numerous modifications and variations on the present invention are possible in light of the above teachings. It is therefore to be understood that within the scope of the appended claims, the invention may be practiced otherwise than as specifically described herein.

The priority document of the present application, Japanese Patent Application No. 176988/1988 filed Jun. 24, 1998, is incorporated herein by reference.

1. A process for producing a modified cheese whey protein, comprising:
(a)
(i) adjusting the pH of an aqueous solution comprising a cheese whey protein to an alkaline pH, or
(ii) heating an aqueous solution comprising a cheese whey protein, or
(iii) adjusting the pH of an aqueous solution comprising a cheese whey protein to an alkaline pH and heating the solution; and thereafter
(b) reacting the cheese whey protein with a transglutaminase, to produce the modified cheese whey protein.

2. The process of claim 1, comprising (a) (i).

3. The process of claim 2, wherein said alkaline pH is 7 to 9.

4. The process of claim 2, wherein (b) is conducted at an alkaline pH.

5. The process of claim 2, wherein (b) comprises heating the solution.

6. The process of claim 2, wherein (b) is conducted at an alkaline pH and wherein (b) comprises heating the solution.

7. The process of claim 1, comprising (a) (ii).

8. The process of claim 7, wherein the solution is heated at 50 to 80° C.

9. The process of claim 7, wherein (b) is conducted at an alkaline pH.

10. The process of claim 7, wherein (b) comprises heating the solution.

11. The process of claim 7, wherein (b) is conducted at an alkaline pH and wherein (b) comprises heating the solution.

12. The process of claim 1, comprising (a) (iii).

13. The process of claim 12, wherein the pH of the solution is adjusted to 7 to 9 in (a) (iii).

14. The process of claim 12, wherein the solution is heated at 50 to 80° C. in (a) (iii).

15. The process of claim 1, wherein the transglutaminase is in an amount from 0.1 to 100 units per gram of cheese whey protein.

16. The process of claim 1, further comprising, subsequent to (b), heating the aqueous solution to a temperature and for a time such that the cheese whey protein is not insolubilized, and drying the product.

17. A process for producing a modified cheese whey protein, comprising:
adjusting the pH of an aqueous solution comprising a cheese whey protein with an alkaline substance to a pH of 7 to 9 and heating the solution at a temperature of 50 to 80° C.,
adding 0.1 to 100 units of a transglutaminase per gram of cheese whey protein,
reacting the transglutaminase and the cheese whey protein for 5 minutes to 48 hours, and
isolating the modified cheese whey protein.

18. The process of claim 17, further comprising, subsequent to said isolating, heating the aqueous solution to a temperature and for a time such that the cheese whey protein is not insolubilized, and drying the product.

19. A modified cheese whey protein obtained by the process of claim 1.

20. A method of making a food composition, comprising adding the modified cheese whey protein of claim 19 to a food.

21. A food composition obtained by the process of claim 20.
